(19) United States
(12) Patent Application Publication
(10) Pub. No.: US 2002/0122950 A1
(43) Pub. Date: Sep. 5, 2002

(54) Polymeric binder for adherent coatings

(75) Inventors: Grant M. Ehrlich, Pawcatuck, CT (US); Frank J. Puglia, West Kingston, RI (US)

Correspondence Address: John R. Doherty, P.O. Box 706, Stevenson, CT, 06491-0706, US

(73) Assignee: Yardney Technical Products, Inc.

(21) Appl. No.: 10/073,750

(22) Filed: Feb. 9, 2002

Related U.S. Application Data
(62) Division of application No. 09/231,275, filed on Jan. 15, 1999.
(60) Provisional application No. 60/071,670, filed on Jan. 16, 1998.

(51) Int. Cl. B32B 15/08

(52) U.S. Cl. 428/463; 427/388.1; 427/387

(57) ABSTRACT

A novel and improved polymeric coating composition and method for applying adherent film coatings to metallic substrates is provided wherein a finely divided or powdered coating material, such as ceramic powders, carbon powders or metallic particles, is substantially uniformly dispersed within a polymeric binder comprising a host polymer and a suitable bonding promoter. The use of a bonding promoter allows a significant amount of cross-linking to occur in situ after the coating composition has been applied to the metallic substrate thereby achieving good adherence between the coating and the substrate and improving the robustness of the coating. The host polymer is preferably a copolymer of poly(vinylidene-fluoride)-hexafluoropropylene copolymers and the bonding promoter is preferably a material selected from the group Bis(trimethoxysilypropyl)amine, hepta(decafluoro-1,1,2,2-tetrahydrodecyl)triethoxy silane, bis[3-(trimethoxysilylpropyl)]ethylenediamine, or N-(2-aminoethyl)3-aminopropyl-triethoxysilane.

This application is a division of our co-pending application Ser. No. 09/231,275, filed on Jan. 15, 1999, which in turn claims priority to our provisional application Serial No. 60/071,670, filed on Jan. 16, 1998.

### BACKGROUND OF THE INVENTION

1. Field of the Invention

The present invention relates to a polymeric coating composition and method for making thick or thin, free standing films or thick or thin films with good adhesion to metallic or other rigid substrates. More particularly, the invention relates to a novel and improved polymeric binder system for use in coating compositions which significantly improves adhesion of the coating or film to the substrate.

2. Description of the Prior Art

Of particular interest to the battery industry and also to other industries which use coatings, are methods to form a conformal, homogeneous coating of a powder, such as a ceramic or carbon powder, on metallic substrates, using binder materials which are resistant to oxidation and compatible with other components such as battery materials. In the lithium-ion (Li-ion) battery industry, for example, such coatings are used to fabricate both positive and negative electrodes of the battery. In a typical process, the electrochemically active battery material is suspended in a solvent containing a polymeric binder. Commonly other additives, such as conductive additives, may be added to the suspension to enhance the electrode's electrical or electrochemical performance. Also of interest in the battery industry are methods for the fabrication of free standing firms of battery materials without the use of a supporting substrate.

The mixture of solvent, binder, ceramic or carbon powder and other additives is commonly referred to as a resin. The role of the binder is to enhance adhesion of the coating. In the case of free standing films, the role of the binder is to adhere particles of the coating together, otherwise in the case of adherent coatings, the role of the binder is to adhere the particles of the coating to themselves and the substrate. A common problem, however, with these processes is that the particles in the coatings do not adhere well to the coating, thus the coating is brittle and fragile, and in the case of adherent coatings, the coating does not adhere well to the metallic substrate, resulting in poor electrochemical cell performance as the coating delaminates from the substrate.

For example, in U.S. Pat. No. 5,296,318 issued to A. S. Gozdz et al. on Mar. 22, 1994, there is disclosed the fabrication of lithium-ion polymeric batteries using poly(vinylidene-fluoride)(PVDP) polymers and poly(vinylidene-fluoride)-hexafluoropropylene (PVDF-HFP) copolymers as binders to form electrode and electrolyte materials for such batteries. In this prior art, the polymeric binder is dissolved in a suspension of the electrochemically active battery material in a solvent, such as acetone, and the suspension is cast to form a free standing film. Such free standing films do not adhere well to metallic substrates and consequently it is necessary to cast the suspension about a metallic grid which remains in the film after evaporation of the solvent.

Films or coatings prepared using only PVDF or only PVDF-HFP as the binder do not adhere well to metallic surfaces and do not adhere well to themselves thus are brittle unless large amounts of binder (greater than about 10% by weight) are used. The use of large amounts of binder is disadvantageous as it displaces the electrochemically active material in a battery or active material in another device. In the prior art, approximately 20 to 40 percent of the coating by weight was binder, thus significantly limiting battery capacity.

### SUMMARY THE INVENTION

The present invention provides a novel and improved polymeric coating composition and method for applying adherent film coatings to metallic substrates. The polymeric coating composition comprises finely divided or powdered coating material, such as ceramic powders, carbon powders or metallic particles, substantially uniformly dispersed within a polymeric binder comprising a host polymer and a suitable bonding promoter. The use of a suitable polymer and bonding promoter serves to form a bond between the coating and the substrate, particularly metallic substrates, and the bonding promoter serves to strengthen bonds within the coating making the coating more robust and resistant to abuse. The result is a strong, flexible, free standing film or coating which adheres well to metallic substrates with minimal additional processing.

The method for applying adherent film coatings to metallic substrates according to the invention comprises first forming a polymeric binder solution containing a host polymer, such as PVDF-HFP, and a bonding promoter in a suitable solvent, subsequently mixing the polymeric binder solution with the finely divided or powdered material to be incorporated into the coating, and casting or spreading the mixture onto the metallic or other substrate and then allowing cross-linking of the binder to itself and the substrate to occur in situ with excellent adherence to the substrate.

A reason for poor adhesion of coatings prepared in prior art is believed to be attributed to the use of binders, such as PVDF or PVDF-HFP, without the use of a bonding additive to effect a bond between the coating and the substrate or the coating and itself. When a bonding additive is used according to the invention, the binder is cross-linked in situ both between the coating and the substrate and the components of the coating to themselves, forming a material much more robust than those prepared without the bonding promoter.

In contrast to coatings prepared in the prior art, wherein approximately 20 to 40 percent of the coatings by weight was binder, the coatings prepared using the present invention contain typically 4 percent and as little as 2 percent binder by weight, thus significantly increasing battery capacity, for example, in the case of Li-ion batteries.

### DESCRIPTION OF THE PREFERRED EMBODIMENTS

The present invention permits the facile formation of a coating which adheres very well to metallic substrates with minimal processing and over a wide range of binder concentrations. This is made possible by utilizing a polymeric binder for the coating material which employs, along with a host polymer, such as PVDF-HFP, a bonding promoter which allows polymerization of the binder to occur in situ after the coating composition has been applied to the metallic substrate and bonding of the coating to the substrate. The polymeric binder solution is mixed with a suspension of the powdered coating material in a suitable solvent, such as acetone or 1-methyl-2-pyrrolidinone, and the mixture is cast or spread onto a suitable substrate to form a free standing film or adherent coating. The film or coating adheres to metallic substrates and results in a strong and flexible material which can withstand abusive conditions over a broad temperature range. The coating may be of ceramic or carbon powders or may be a finely divided material such as metallic particles. Preferably, the coating material is a powdered electrochemically active material such as a lithium compound (e.g. LiCoO₂), for fabricating positive electrodes, or carbon, or a tin compound, for fabricating negative electrodes for use in Lithium-ion batteries. The invention permits fabrication of adherent or free standing films using a small concentration of binder, roughly about half that of prior art films, which is of particular interest to the battery industry. Further, the polymeric binder is highly stable and chemically compatible with Li-ion battery materials and thus is particularly useful for Li-ion electrochemical cells.

One of the component parts of the polymeric binder of the invention is the host polymer. The host polymer may be any one of a number of polymers or copolymers including particularly poly(vinylidene-fluoride)polymers (PVDF), poly(vinylidene-fluoride)-hexafluoropropylene (PVDF-HFP) copolymers and poly(vinyl pyrrolidinone) (PVP). Other polymers suitable for use as the host polymer include poly(acrylonitrile), poly(phosphazine) and poly(methylmethacrylate), for example. Preferably, the host polymer is a copolymer of PVDF-HFP. PVDF-HFP copolymers are commercially available, both Kynar or Solef are examples of commercially available PVDF-HFP copolymers. (“Kynar” and “Solef” are trademarks owned by Alf Atochem and Solvay, respectively). These materials are typically utilized in formulations which contain about 8 to 12% HFP.

Optionally the binder may employ an uncured polymer or elastomer. Such an elastomer is preferably fluorinated, such as viton rubber, a linear copolymer of vinylidine fluoride and hexafluoropropylene (HFP) where the polymer contains greater than 25% HFP and preferably typically about 40% HFP. Typically this elastomer is utilized in a solution of methyl ethyl ketone, for example.

Another important component of the polymeric binder of the invention is the bonding promoter. The bonding promoter used in the practice of the invention may be any one of many bifunctional molecules. The bonding promoter utilized in most of the experiments leading to the invention is Bis(trimethoxysilylpropyl)arnine. Other cross-linking agents that have been utilized include hepta(decafluoro-1,1,2,2-tetrahydrodecyl)triethoxy silane, bis[3-(trimetholysilyl)propyl]ethylenediamine and N-(2-aminoethyl)3-aminopropyl-triethoxysiliane. The bonding promoter is typically used in an ethanol and/or methanol solution. As described in Table 1, these materials offer various levels of adhesion. Adhesion in this case was measured by the change in the mass of a coating after application of a pressure sensitive adhesive, application of a calibrated force and removal of the pressure sensitive adhesive. Thus adhesion was measured according to ((Mass Adhered/Mass Total)−1).

TABLE 1
Adhesion achieved with candidate bonding promoter.

| Bonding Promoter Agent | Adhesion |
|---|---|
| Bis-(trimethoxysilylpropyl)amine | 0.461 |
| Bis [3-(trimethoxysilyl)propyl] ethylenediamine | 0.594 |
| N-(2-aminoethyl)3-aminopropyl-triethoxysilane | 0.113 |

Although the various components of the polymeric binder according to the invention may be used over a wide range of concentrations, it is generally preferred to employ the host polymer in amounts ranging from about 1 to about 10 percent by weight of the coating while the bonding promoter is preferably used in amounts ranging from about 0.001to about 1 percent by weight of the total coating.

The powdered coating material is normally the major ingredient of the coating composition particularly when used to fabricate battery or cell electrodes. Typically, the coating material will constitute from about 90 to about 99 weight percent of the total coating composition.

The following examples will serve to further illustrate the features of the invention.

### EXAMPLE 1

The bonding promoter was prepared by mixing methanol, ethanol and bis-(trimethoxysilylpropyl)amine in the ratio 4:3:6 while attention was paid to the exclusion of adventitious water from the material. This solution was stirred. A polymeric binder solution was prepared by stirring a mixture of 1-methyl-2-pyrrolidinone (50 g), PVDF-HFP (2.5 g) and the bonding promoter (0.31 g) until a clear solution resulted, typically 1 to 30 minutes. A coating resin was prepared by mixing the polymeric binder solution with graphitic carbon (47.2 g).

A negative electrode for a lithium ion electrochemical cell was prepared by casting a resin onto 18 μm copper foil using a knife-over-roll coating machine. The machine spreads the resin onto the substrate in a homogeneous fashion in the range of 0.05 g/in² to 0.50 g/in², and typically 0.20 g/in². After application of the resin to the foil, the material was passed through an oven with maximum temperature of 130° C. for 5 minutes to remove the volatile components and effect bonding of the coating to the copper foil and bonding of the coating to itself. The resulting coating was adherent. The resulting coating was prepared such that after removal of the volatile components, the final coating contained about 95 percent by weight carbon, 4.95 percent weight PVDF-HFP copolymer, and 0.05 percent by weight bonding promoter.

### EXAMPLE 2

In a second example a material was prepared using the method described in example 1 but substituting bis[3-trimethoxysilyl)propyl]ethylenediamine for bis-(trimethoxysilylpropyl)amine as used in Example 1. The resulting coating was also adherent.

### EXAMPLE 3

In a third example a material was prepared using the method described in example 1 but substituting N-(2-aminoethyl)3-aminopropyl-triethoxysilane for bis-(trimethoxysilylpropyl)amine as used in Example 1. The resulting coating was also adherent.

### EXAMPLE 4

The bonding promoter was prepared by mixing methanol (3.525 g), ethanol (15.725 g) and N-(2-aminoethyl)3-aminopropyl-triethoxysilane(5.75 g) while attention was paid to the exclusion of adventitious water from the material. This solution was stirred. A polymeric binder solution was prepared by stirring a mixture of 1-methyl-2-pyrrolidinone (4060 g), PVDF-HFP (356 g) and the bonding promoter (36 g) resulting in a clear solution. A coating resin was prepared by mixing the polymeric binder solution with graphitic carbon (3240 g).

A negative electrode for a lithium ion electrochemical cell was prepared by casting a resin onto 18 μm copper foil using a knife-over-roll coating machine. The machine spread the resin onto the substrate in a homogeneous fashion at a level of 0.06 g/in². After application of the resin to the foil, the material was passed through an oven with maximum temperature of 130° C. for 5 minutes to remove the volatile components and effect bonding of the coating to the copper foil and bonding of the coating to itself. The resulting coating was adherent. The resulting coating was prepared such that after removal of the volatile components, the final coating contained 95 percent by weight carbon, 4.95 percent weight PVDF-HFP copolymer, and 0.05 percent by weight bonding promoter.

### EXAMPLE 5

In another experiment a coating was made similar to example 4 but without the bonding promoter. In this example, a binder solution was prepared by stirring a mixture of 1-methyl-2-pyrrolidinone (4060 g) and PVDF-HFP (356 g), resulting in a clear solution. A coating resin was prepared by mixing the polymeric binder solution with graphitic carbon (3240 g).

A negative electrode for a lithium ion electrochemical cell was prepared by casting a resin onto 18 μm copper foil using a knife-over-roll coating machine. The machine spread the resin onto the substrate in a homogeneous fashion at a level of 0.056 g/in². After application of the resin to the foil, the material was passed through an oven with maximum temperature of 130° C. for 5 minutes to remove the volatile components and effect bonding of the coating to the copper foil and bonding of the coating to itself. The resulting coating did not adhere to the copper foil well, when the material was handled the coating delaminated from the foil. The resulting coating was prepared such that after removal of the volatile components, the final coating contained 95 percent by weight carbon and 5 percent weight PVDF-HFP copolymer.

To summarize, the invention provides a polymeric binder system for fabricating coatings on metallic substrates with excellent adhesion achieved between the metallic substrate and the coating. The novel components of the binder include a bonding promoter, such as Bis(trimethoxysilylpropyl)amine, and a host polymer, such as vinylidene fluoride-hexafluoro propylene copolymer to form the adherent coatings. The above described polymeric binder system is particularly useful for forming coatings for application in electrochemical cells.

What is claimed is:

1. A polymeric coating composition for applying adherent film coatings to metallic substrates comprising a powdered coating material substantially uniformly dispersed within a polymeric binder comprising a host polymer and a bonding promoter to effect polymerization of said polymer and bonding promoter in situ after said coating composition has been applied to said metallic substrate.

2. A coating composition according to claim 1 wherein said powdered coating material is selected from the group consisting of ceramic powders, carbon powders, metallic powders and mixtures thereof.

3. A coating composition according to claim 2 wherein said host polymer is selected from the group consisting of poly(vinylidene-fluoride) homopolymers, poly(vinylidene-fluoride)-hexafluoropropylene copolymers, poly(vinyl pyrrolidinone, bis[3-(trimethoxysilylpropyl)]ethylenediamine, and N-(2-aminoethyl)3-aminopropyl-triethoxysilane polymers and mixtures thereof.

4. A coating composition according to claim 3 wherein said host polymer, is a poly(vinylidene-fluoride)-hexafluoropropylene copolymer.

5. A coating composition according to claim 1 wherein said bonding promoter is selected from the group consisting of Bis(trimethoxysilypropyl)amine, hepta(decafluoro-1,1,2,2-tetrahydrodecyl)triethoxy silane, bis[3-(trimethoxysilylpropyl)]ethylenediamine, and N-(2-aminoethyl)3-aminopropyl-triethoxysilane, and mixtures thereof.

6. A polymeric binder system for fabricating coatings on metallic substrates comprising a host polymer and a bonding promoter to promote polymerization of said polymer and bonding promoter in situ after said coating composition has been applied to said metallic substrate.

7. A polymeric binder system according to claim 6 wherein said host polymer is selected from the group consisting of poly(vinylidene-fluoride) homopolymers, poly(vinylidene-fluoride)-hexafluoropropylene copolymers, poly(vinyl pyrrolidinone, poly(acrylonitrile), poly(phosphazine) and poly(methylmethacrylate) polymers and mixtures thereof.

8. A polymeric binder system according to claim 7 wherein said host polymer is a poly(vinylidene-fluoride)-hexafluoropropylene copolymer.

9. A polymer binder system according to claim 6 wherein said bonding promoter is selected from the group consisting of Bis(trimethoxysilypropyl)amine, hepta(decafluoro-1,1,2,2-tetrahydrodecyl)triethoxy silane, bis[3-(trimethoxysilylpropyl)]ethylenediamine, and N-(2-aminoethyl)3-aminopropyl-triethoxysilane and mixtures thereof.

10. A method for applying an adherent film coating to a metallic substrate comprising forming a polymeric binder containing a host polymer and a bonding promoter, mixing the polymeric binder with a finely divided coating material, and spreading the so formed polymeric coating composition onto said metallic substrate while allowing cross-linking of the binder to occur in situ thereby achieving good adherence between said coating composition and said substrate.

11. A coating method according to claim 10 wherein said coating material is selected from the group consisting of ceramic powders, carbon powders, metallic powders and mixtures thereof.

12. A coating method according to claim 11 wherein said host polymer is selected from the group consisting of poly(vinylidene-fluoride) homopolymers, poly(vinylidene-fluoride)-hexafluoropropylene copolymers, poly(vinyl pyrrolidinone, poly(acrylonitrile), poly(phosphazine) and poly(methylmethacrylate) polymers and mixtures thereof.

13. A coating method according to claim 12 wherein said bonding promoter is selected from the group consisting of Bis(trimethoxysilypropyl)amine, hepta(decafluoro-1,1,2,2-tetrahydrodecyl)triethoxy silane, bis[3-(trimethoxysilylpropyl)]ethylenediamine, and N-(2-aminoethyl)3-aminopropyl-triethoxysilane and mixtures thereof.

14. A film coating for a metallic substrate comprising a powdered coating material substantially uniformly dispersed throughout a solid polymeric matrix composed of a mixture comprising at least one host polymer selected from the group consisting of poly(vinylidene-fluoride) homopolymers, poly(vinylidene-fluoride)-hexafluoropropylene copolymers, poly(vinyl pyrrolidinone, poly(acrylonitrile), poly(phosphazine) and poly(methylmethacrylate) polymers and mixtures thereof and a bonding promoter selected from the group consisting of Bis(trimethoxysilypropyl)amine, hepta(decafluoro-1,1,2,2-tetrahydrodecyl)triethoxy silane, bis[3-(trimethoxysilylpropyl)]ethylenediamine, and N-(2-aminoethyl)3-aminopropyl-triethoxysilane.

15. A film coating according to claim 14 wherein said powdered coating material selected from the group consisting of ceramic powders, carbon powders, metallic powders and mixtures thereof.

16. A lithium battery electrode according to claim 15 wherein said powdered coating material contains carbon.

17. A lithium battery electrode according to claim 15 wherein said powdered coating material contains a lithium compound.
